(19) United States
(12) Patent Application Publication
(10) Pub. No.: US 2012/0063151 A1
(43) Pub. Date: Mar. 15, 2012

(54) ILLIMINATION DEVICE WITH AFTERGLOW CHARACTERISTICS

(75) Inventors: Thomas Juestel, Witten (DE); Joerg Meyer, Aachen (DE); Klaus Schoeller, Nideggen (DE); Juergen Flechsig, Plauen (DE); Petra Huppertz, Roetgen (DE); Detlef U. Wiechert, Alsdoft (DE); Danuta A. Dacyl, Steinfurt (DE); Dietmar D. Bayerlein, Jobnitz (DE)

(73) Assignee: KONINKLIJKE PHILIPS ELECTRONICS N.V., EINDHOVEN (NL)

(21) Appl. No.: 13/320,042

(22) PCT Filed: May 7, 2010
(86) PCT No.: PCT/IB10/52026

§ 371 Date: Nov. 11, 2011

(30) Foreign Application Priority Data
May 13, 2009 (EP) 09160126.0
Jun. 25, 2009 (EP) 09163731.4

(51) Int. Cl. F21V 11/00; C09K 11/78

(52) U.S. Cl. 362/311.03; 252/301.4 R

(57) ABSTRACT

The invention relates to illumination devices (1) with a light source (2) and an afterglow surface (4) comprising a phosphor. The phosphor has an afterglow emission peak at a temperature above about 100° C. and/or has the formula (Sr_{1-z}M_{z})₄Al₁₄O₂₅:Eu, Ln, Xₖ with M ε {Ca, Ba, Mg}, Ln ε {Dy, Nd}, X ε {Yb, Tm, Sm}.

### FIELD OF THE INVENTION

The invention relates to an illumination device with afterglow characteristics. Moreover, it relates to a phosphor for lighting applications and a method for its production.

### BACKGROUND OF THE INVENTION

In US 2005/0242736 A1, an incandescent lamp is described with a glass bulb that is coated with a phosphor to produce an afterglow effect after the lamp has been switched off. The phosphor has the general formula MAl₁₄O₂₅, where M is one or more of Ca, Sr and Ba.

### SUMMARY OF THE INVENTION

Based on this background, it is an object of the present invention to provide illumination devices with improved afterglow characteristics.

This object is achieved by a phosphor according to claim 1 and illumination devices according to claims 8 and 9. Preferred embodiments are disclosed in the dependent claims.

According to a first aspect, the invention relates to a phosphor for lighting applications, particularly for illumination devices with afterglow characteristics. The phosphor is composed according to the following general formula:

(Sr_{1-z},M_{z})₄Al₁₄O₂₅:Eu, Ln, Xₖ (1)

wherein
the variable M represents one of the alkaline-earth metals Ca, Ba, and Mg;
the variable Ln represents one of the lanthanides Dy and Nd;
the variable X represents one of the lanthanides Yb, Tm, and Sm.

Furthermore,
the index z is chosen from the interval [0, 1 [;
the index k is either 1 or 0 (indicating that the component X is present or not);
k is not equal to 0 if z is 0, implying that at least one of the components M and X must be present.

The above formula (1) describes a new phosphor which surprisingly has advantageous afterglow characteristics. Experiments show that afterglow is particularly improved for higher temperatures, for example temperatures above 100° C. In practice this is very favorable as such high temperatures often correspond to the operating temperatures of illumination devices.

The invention further relates to a method for the production of a phosphor of the kind described above, said method comprising the following steps:

a) Mixing raw materials which comprise the elements of the phosphor, i.e. Sr, M (=Ca, Ba, or Mg), Al, O, Eu, Ln (=Dy or Nd), and (if present) X (=Yb, Tm, or Sm). The elements (besides oxygen, O) are preferably supplied in amounts as stoichiometrically required by formula (1).

b) Annealing the obtained mixture at temperatures above about 900° C. in a gaseous atmosphere.

The raw materials that are used for the preparation of the phosphor in step a) may preferably comprise the metallic elements of the phosphor as oxides and/or carbonates. In particular, the raw materials may comprise the compounds SrCO₃, MCO₃ (M=Ca, Ba, or Mg), Eu₂O₃, Ln₂O₃ (Ln=Dy or Nd), X₂O₃ (X=Yb, Tm, or Sm), and Al₂O₃.

Furthermore, the method may optionally comprise one or more of the following steps:
the addition of H₃BO₃ as a flux to the mixture of step a);
grinding the mixture of step a) with acetone;
milling the annealed mixture to obtain a fine powder of the phosphor.

In the following, various embodiments of the invention will be described that relate to both the phosphor and the method described above.

Thus, the production of the phosphor of formula (1) preferably comprises several annealing steps, wherein each step comprises the application of a different gaseous atmosphere and/or a different temperature. Most preferably, three such annealing steps are applied.

Moreover, the production of the phosphor of formula (1) may optionally comprise annealing in a gaseous atmosphere comprising air, CO, N₂, and/or H₂. Preferably, there are three annealing steps taking place consecutively in the following different gaseous atmospheres: air, CO, and N₂/H₂.

During its production, the phosphor according to formula (1) has preferably been annealed at a temperature between about 1300° C. and about 1500° C., preferably at a temperature of about 1400° C. Such annealing is typically executed as a final step of the production process. Moreover, the duration of the annealing is preferably in the range of about one to six hours.

According to a preferred embodiment of the invention, the index z of the formula (1) ranges between about 0.05 and about 0.15. Most preferably, z has a value of about 0.1±10%. It has been found that such comparatively small fractions of the metal M can considerably improve the afterglow characteristics of the phosphor.

Formula (1) for the phosphor does not specify the relative amounts of the dopants Eu, Ln, and X. Preferably, these dopants are present however in comparatively small fractions ranging between about 0.01 atom-% and 10 atom-%. Particularly preferred amounts are about 1 atom-% for Eu, about 0.05 atom-% for Ln, and/or about 0.1 atom-% for X.

According to a second aspect, the invention relates to an illumination device with a light source and an afterglow surface which is illuminated by said light source and which comprises a phosphor having an afterglow emission peak at a temperature above about 100° C., preferably above about 200° C. In this context, the “afterglow emission peak” is determined by recording the emission intensity of the phosphor as a function of temperature after exciting the phosphor at a low temperature, wherein the temperature of the phosphor is raised at a constant rate during the measurement. Typical rates at which the temperature is raised during the measurement range between about 10 K/min and 100 K/min and are preferably about 50 K/min. The described measurement yields an “afterglow curve”, wherein a peak of this curve (if present) is by definition an “afterglow emission peak”. Usually the existence and location of an afterglow emission peak on the temperature scale do not very critically depend on the particular rate of temperature increase that is applied during the measurement.

The light source of the illumination device may be any component that can actively generate light, for example a filament of an incandescent lamp.

The described illumination device has improved characteristics because the afterglow of its phosphor is high even at temperatures above 100° C. due to the existence of an emission peak in said range. Afterglow is thus optimized at temperatures that correspond to the usual operating temperatures of illumination devices, particularly of incandescent lamps.

According to a third aspect, the invention relates to an illumination device with a light source and an afterglow surface that comprises a phosphor of the kind described above, i.e. a phosphor according to formula (1).

An illumination device may preferably have the features of both illumination devices according to the second and third aspect of the invention, i.e. comprise a phosphor according to formula (1) that has an afterglow emission peak at a temperature above about 100° C.

According to a further development of the above illumination devices, the afterglow surface comprising the phosphor is arranged on a transparent cover of the light source. Said transparent cover may for instance be the glass bulb of an incandescent lamp. Arranging the phosphor on a transparent cover has the advantage that light of the light source may be transmitted through the phosphor (and the cover), thus exposing the phosphor optimally to excitation illumination.

According to another embodiment, the phosphor is arranged on a carrier (e.g. socket, basement) of the light source or even on the light source (e.g. a filament) itself. These options have the advantage that afterglow can originate from a location close to the light source, which is however usually accompanied by the requirement to be resistant to high operating temperatures.

In the aforementioned cases, the phosphor is preferably disposed as a layer on the cover, said layer having a thickness between about 1 μm and about 1000 μm, preferably between about 20 μm and 200 μm.

### BRIEF DESCRIPTION OF THE DRAWINGS

These and other aspects of the invention will be apparent from and elucidated with reference to the embodiment(s) described hereinafter. These embodiments will be described by way of example with the help of the accompanying drawings in which:

FIG. 1 illustrates a proposed mechanism of persistent luminescent materials based on Eu²⁺ doped aluminates;

FIG. 2 shows the emission intensity of (Sr_{0.9}Ca_{0.1})₄Al₁₄O₂₅:Eu,Dy,X as a function of time;

FIG. 3 shows the emission intensity of (Sr_{1-z},Ca_{z})₄Al₁₄O₂₅:Eu,Dy as a function of z and time;

FIG. 4 shows glow curves of (Sr_{0.9}Ca_{0.1})₄Al₁₄O₂₅:Eu(1%),Dy(0.05%),Tm(0.1%) made at 1250° C. (DD137), at 1300° C. (DD138), and at 1400° C. (DD146), (Sr_{0.9}Ca_{0.1})₄Al₁₄O₂₅: Eu(1%),Dy(0.05%),Sm(0.1%) (DD140), and (Sr_{0.9}Ca_{0.1})₄Al₁₄O₂₅: Eu(1%),Dy(0.05%),Yb(0.1%) (DD145);

FIG. 5 shows an incandescent lamp with a phosphor coating according to the present invention.

### DESCRIPTION OF PREFERRED EMBODIMENTS

Afterglow pigments are mostly Eu² doped aluminates or silicates, which are co-doped with Dy³⁺ or Nd³⁺, resulting in compositions such as SrAl₂O₄:Eu,Dy, CaAl₂O₄:Eu,Nd, or Sr₄Al₁₄O₂₅:Eu,Dy, wherein the observed afterglow is a sensitive function of the type and concentration of the co-dopant.

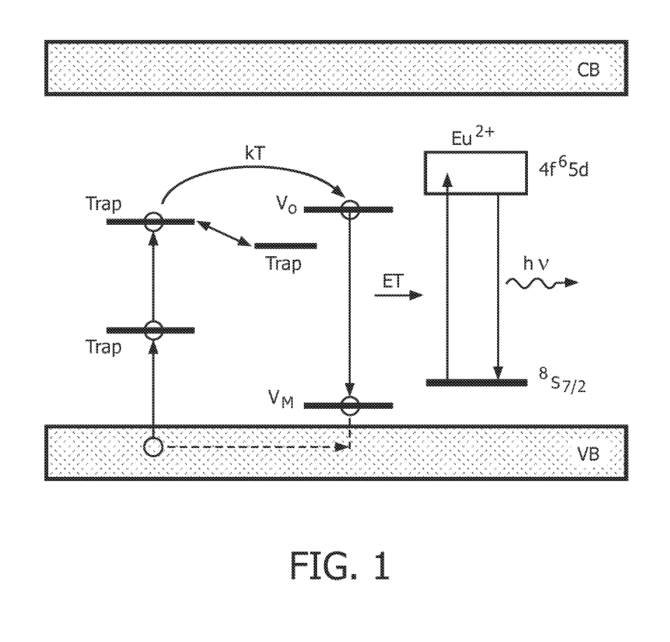

FIG. 1 illustrates state transitions of electrons between the valence band (VB) and the conduction band (CB) according to the most widely accepted model to explain afterglow in Eu²⁺ doped aluminates. This model involves oxygen vacancies as electron traps, which are located close to Eu²⁺, which in turn act as deep hole traps (M. J. Knitel, P. Dorenbos, C. W. E. van Eijk; J. Luminescence 72-74 (1997) 765). The role of the trivalent co-dopant is the introduction of oxygen vacancies and lattice distortions, which will give rise to the formation of oxygen defects. Moreover, the most efficiently working trivalent ions as a co-dopant to cause afterglow are Dy³⁺ and Nd³⁺, since these ions easily act as hole traps, i.e. their redox potential for oxidation to the tetravalent state is rather low.

Commercially available afterglow pigments, as given above, show persistent afterglow at room temperature. However, an optimized afterglow pigment for application onto light sources should show at least one glow peak at a temperature above the temperature of the light source component under operation on to which it is coated.

It is therefore proposed here to use phosphors exhibiting at least one glow peak at a temperature above 100° C. (373 K), more preferably above 200° C. (473 K), and to apply them onto (hot) parts of light sources or luminaries.

Furthermore, it is proposed to optimize the persistent afterglow pigment Sr₄Al₁₄O₂₅:Eu,Dy by the replacement of Sr²⁺ with other alkaline-earth ions (Mg²⁺ or Ca²⁺ or Ba²⁺). It was surprisingly found that the substitution of 10% Sr²⁺ with Ca²⁺ gives a much more intense and persistent afterglow at room temperature. FIG. 3 shows this in a diagram of the emission intensity (vertical axis, in photon counts per second) of (Sr_{1-z}Ca_{z})₄Al₁₄O₂₅:Eu,Dy as a function of z and time. It is assumed that this effect can be attributed to the formation of a eutectic blend, resulting in a lower crystallization temperature of the Sr₄Al₁₄O₂₅ phase.

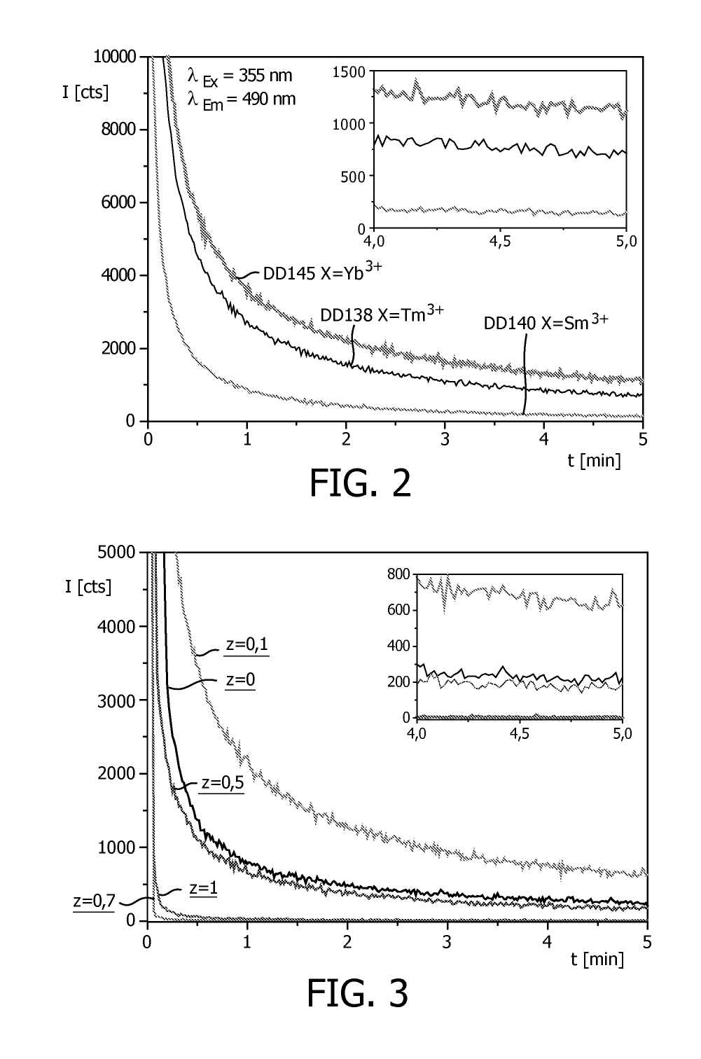

To improve the afterglow of (Sr,Ca)₄Al₁₄O₂₅:Eu,Dy at the temperature of a given application, e.g. at about 150° C., it was found that its modification by the application of an additional co-dopant is of advantage. An improvement of the persistence of the afterglow at room temperature (FIG. 2) or at a high temperature, e.g. 150 or 300° C., is achieved by the addition of another trivalent rare earth ion. It was surprisingly found that the application of Yb³⁺ as an additional dopant improves the afterglow at room temperature, but it also quenches the afterglow at a temperature above 150° C.

In contrast to the above, co-doping of (Sr,Ca)₄Al₁₄O₂₅:Eu,Dy with Tm³⁺ results in a slightly worse afterglow at room temperature, but in a much more persistent afterglow at a high temperature, e.g. at 300° C.

Finally, it was found that the persistence and intensity of the afterglow of a given composition, e.g. of (Sr,Ca)₄Al₁₄O₂₅:Eu,Dy,Tm, is a sensitive function of the synthesis temperature. The best results with respect to the afterglow intensity and persistence are achieved if the final annealing step is performed at about 1400° C.

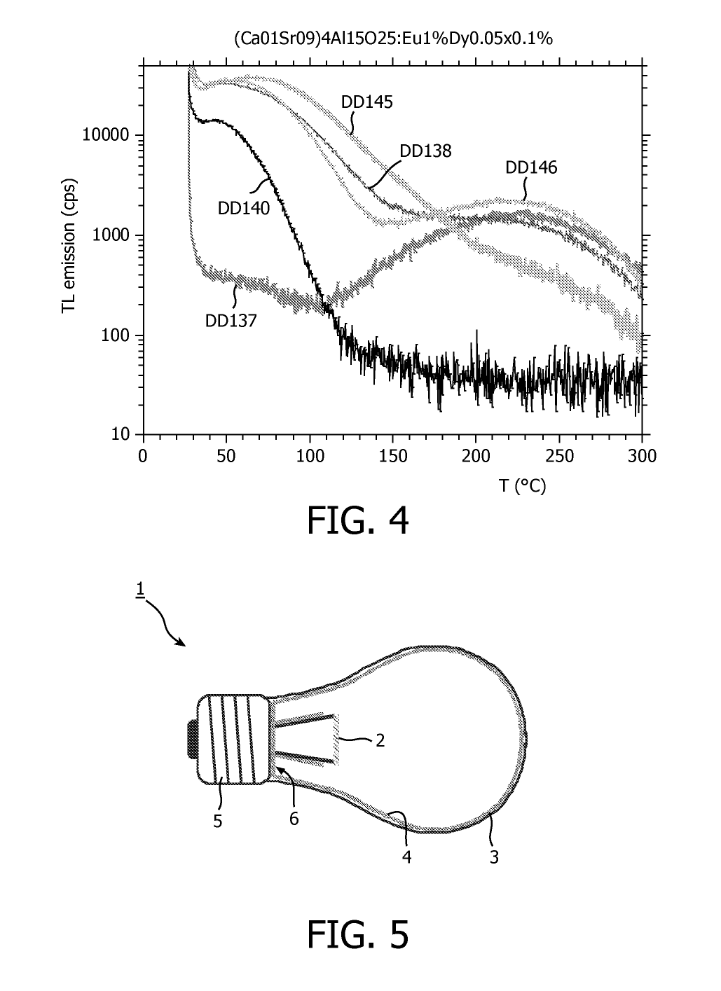

FIG. 4 shows in a diagram the emission (expressed in counts per second, vertical axis) along the so-called glow curves obtained by a TL experiment. This means that the emission intensity is recorded as a function of temperature T after charging the material at a low temperature. During the experiment, the temperature T is linearly raised at a constant rate, and the emission (TL) intensity is measured as a function of temperature (i.e. as a function of time, since a temperature ramp is applied).

The different curves represent the effect of the different co-dopants (Tm, Sm, Yb) and of the temperature of the final annealing step (1250° C., 1300° C., 1400° C.) according to the following key:

DD137: (Sr_{0.9}Ca_{0.1})₄Al₁₄O₂₅:Eu(1%),Dy(0.05%),Tm(0.1%) made at 1250° C.

DD138: (Sr_{0.9}Ca_{0.1})₄Al₁₄O₂₅:Eu(1%),Dy(0.05%),Tm(0.1%) made at 1300° C.

DD146: (Sr_{0.9}Ca_{0.1})₄Al₁₄O₂₅:Eu(1%),Dy(0.05%),Tm(0.1%) made at 1400° C.

DD140: (Sr_{0.9}Ca_{0.1})₄Al₁₄O₂₅:Eu(1%),Dy(0.05%),Sm(0.1%) made at 1400° C.

DD145: (Sr_{0.9}Ca_{0.1})₄Al₁₄O₂₅:Eu(1%),Dy(0.05%),Yb(0.1%) made at 1400° C.

In the following, various examples are provided to demonstrate particularly selected embodiments of the present invention.

### EXAMPLE 1

### High Temperature Afterglow Pigment of the Composition (Sr,Ca)₄Al₁₄O₂₅:Eu(1%)Dy(0.05%)Tm(0.1%)

The required amounts of raw materials, i.e. 0.9265 g SrCO₃, 0.0698 g CaCO₃, 0.0124 g Eu₂O₃, 0.0007 g Dy₂O₃, 0.0014 g Tm₂O₃, 1.3307 g Al₂O₃, and 0.0109 g H₃BO₃ as a flux were weighed in and ground with acetone in an agate mortar. After drying of the blends they were filled into an alumina crucible, which in turn was placed into a tube furnace. The material underwent three annealing steps, which are

1. step: Air/1000° C./4 h

2. step: CO/1200° C./4 h

3. step: N₂/H₂/1300° C./4 h

and was finally milled until a fine powder was obtained.

### EXAMPLE 2

### High Temperature Afterglow Pigment of the Composition (Sr,Ca)₄Al₁₄O₂₅:Eu(1%)Dy(0.05%)Sm(0.1%)

The required amounts of raw materials, i.e. 0.9265 g SrCO₃, 0.0698 g CaCO₃, 0.0124 g Eu₂O₃, 0.0007 g Dy₂O₃, 0.0012 g Sm₂O₃, 1.3307 g Al₂O₃, and 0.0109 g H₃BO₃ as a flux were weighed in and ground with acetone in an agate mortar. After drying of the blends they were filled into an alumina crucible, which in turn was placed into a tube furnace. The material underwent three annealing steps, which are

1. step: air/1000° C./4 h

2. step: CO/1200° C./4 h

3. step: N₂/H₂/1300° C./4 h

and was finally milled until a fine powder was obtained.

### EXAMPLE 3

### High Temperature Afterglow Pigment of the Composition (Sr,Ca)₄Al₁₄O₂₅:Eu(1%)Dy(0.05%)Yb(0.1%)

The required amounts of raw materials, i.e. 0.9265 g SrCO₃, 0.0698 g CaCO₃, 0.0124 g Eu₂O₃, 0.0007 g Dy₂O₃, 0.0012 g Yb₂O₃, 1.3307 g Al₂O₃, and 0.0109 g H₃BO₃ as a flux were weighed in and ground with acetone in an agate mortar. After drying of the blends they were filled into an alumina crucible, which in turn was placed into a tube furnace. The material underwent three annealing steps, which are

1. step: air/1000° C./4 h

2. step: CO/1200° C./4 h

3. step: N₂/H₂/1300° C./4 h

and was finally milled until a fine powder was obtained.

### EXAMPLE 4

A solvent-based paint comprising (Sr,Ca)₄Al₁₄O₂₅:Eu,Dy,Tm as an afterglow pigment was coated onto the basement of an automotive halogen lamp (H4 or H7). A model of the lamp 1 is schematically shown in FIG. 5, and comprises the filament 2, the glass bulb 3, the socket 5, and the coating 4 that covers the inner surface of the bulb 3 and the basement 6 of the light source. The thickness of the coating 4 was 20-200 μm. This lamp showed blue-green (490 nm) persistent emission after the lamp had been switched off.

Finally it is pointed out that in the present application the term “comprising” does not exclude other elements or steps, that “a” or “an” does not exclude a plurality, and that a single processor or other unit may fulfill the functions of several means. The invention resides in each and every novel characteristic feature and each and every combination of characteristic features. Moreover, reference signs in the claims shall not be construed as limiting their scope.

1. A phosphor (4) for lighting applications according to the formula
(Sr_{1-z}M_{z})₄Al₁₄O₂₅:Eu, Ln, Xₖ
with
M being chosen from the group consisting of Ca, Ba, and Mg,
Ln being chosen from the group consisting of Dy and Nd,
X being chosen from the group consisting of Yb, Tm, and Sm,
0≦z<1 and k ε {0; 1} and k≠0 if z=0.

2. A method for the production of a phosphor (4) according to claim 1, comprising the following steps:
a) mixing raw materials which comprise the elements of the phosphor (4);
b) annealing the obtained mixture at temperatures above about 900° C. in a gaseous atmosphere.

3. The method according to claim 2,
characterized in that the raw materials comprise the metallic elements of the phosphor (4) as oxides and/or carbonates.

4. The phosphor (4) according to claim 1,
characterized in that the phosphor (4) has been annealed in several steps, each step comprising the application of a different gaseous atmosphere and/or a different temperature.

5. The phosphor (4) according to claim 1,
characterized in that the phosphor (4) has been annealed in a gaseous atmosphere comprising air, CO, N₂ and/or H₂.

6. The phosphor (4) according to claim 1,
characterized in that the phosphor (4) has been annealed at about 1300° C. to 1500° C.

7. The phosphor (4) according to claim 6,
characterized in that the phosphor (4) has been annealed for between about 1 and about 6 hours.

8. The phosphor (4) according to claim 1,
characterized in that 0.05≦z≦0.15.

9. The phosphor (4) according to claim 1,
characterized in that the phosphor (4) comprises about 0.01 atom-% to about 10 atom-% Eu, preferably about 1 atom-% Eu.

10. The phosphor (4) according to claim 1,
characterized in that the phosphor (4) comprises about 0.01 atom-% to about 10 atom-% Ln, preferably about 0.05 atom-% Ln.

11. The phosphor (4) according to claim 1,
characterized in that the phosphor (4) comprises about 0.01 atom-% to about 10 atom-% X, preferably about 1 atom-% X.

12. An illumination device (1) with a light source (2) and an afterglow surface (4) that comprises a phosphor having an afterglow emission peak at a temperature above about 100° C.

13. An illumination device (1) with a light source (2) and an afterglow surface (4) that comprises a phosphor according to claim 1.

14. The illumination device (1) according to claim 12,
characterized in that the afterglow surface (4) is arranged on a transparent cover (3) of the light source (2), directly onto the light source (2), or on a carrier (5, 6) of the light source.

15. The illumination device (1) according to claim 14,
characterized in that the phosphor is disposed as a layer (4) of a thickness between 1 μm and 1000 μm on the cover (3).
